(19) United States
(12) Patent Application Publication
(10) Pub. No.: US 2015/0308654 A1
(43) Pub. Date: Oct. 29, 2015

(54) SURFACE LIGHT SOURCE USING ARRAYED POINT LIGHT SOURCES

(71) Applicant: SAMSUNG ELECTRONICS CO., LTD., Suwon-si (KR)

(72) Inventors: YOUNGKYU PARK, NAM-GU (KR); KWANG SOO KIM, PYEONGTAEK-SI (KR); WOOKRAE KIM, SUWON-SI (KR); TAEJOONG KIM, SUJI-GU (KR); BYEONGHWAN JEON, YONGIN-SI (KR)

(21) Appl. No.: 14/580,340

(22) Filed: Dec. 23, 2014

(30) Foreign Application Priority Data
Apr. 28, 2014 (KR) 10-2014-0050862

(51) Int. Cl. F21V 5/04; F21V 21/00

(52) U.S. Cl. CPC F21V 5/043; F21V 5/04; F21V 21/00; F21Y 2111/001

(57) ABSTRACT

An optical system includes a light source and a lens structure for transmitting light emitted by the light source. The light source includes a substrate and a plurality of light-emitting devices arranged three-dimensionally on the substrate.

### PRIORITY STATEMENT

This U.S. non-provisional patent application claims priority under 35 U.S.C. §119 to Korean Patent Application No. 10-2014-0050862, filed on Apr. 28, 2014, in the Korean Intellectual Property Office, the entire contents of which are hereby incorporated by reference.

### BACKGROUND

The inventive concept relates to a light source. More particularly, the inventive concept relates to a surface light source having an array of light-emitting devices.

As a semiconductor process technologies advance, the design rule according to which the devices are fabricated has decreased to less than several tens of nanometers. Accordingly, equipment used to inspect the semiconductor devices should have nano-scale resolution. The phenomena of diffraction, though, leads to several technical difficulties in the ability of optical inspection instruments, like bright-field inspection equipment, to achieve a nano-scale resolution. Therefore, it has become necessary of such instruments to use a short-wavelength light-emitting device (e.g., a device that emits deep ultraviolet light having a wavelength of about 200 nm-400 nm).

Conventionally, plasma electrode lamps have been used as a light source for producing ultraviolet light, but such lamps are subject to technical limitations in terms of the intensity, efficiency, and wavelength of the source light that they can produce. Recently, an electrode-less method of generating plasma using a laser or microwaves has been used to produce ultraviolet light. However, this method requires a high-power laser and complex optical system, i.e., requires costly equipment.

### SUMMARY

According to an aspect of the inventive concept, there is provided an system including a light source, and a lens system, and in which the light source includes an optical substrate, and a plurality of light-emitting devices arrayed in three dimensions on the substrate.

According to another aspect of the inventive concept, there is provided a light source including an optical substrate, and a plurality of light-emitting devices arrayed in three dimensions on the optical substrate.

According to another aspect of the inventive concept, there is provided an illuminator having an optical axis and comprising a light source, and a system of optical components disposed downstream from the light source along the optical axis so as to receive light emitted by the light source, and in which the light source comprises a substrate, and light-emitting devices arrayed in three dimensions on the substrate. First and second ones of the three dimensions lie in a plane perpendicular to the optical axis at a downstream end of the light source with respect to the optical axis, and the third one of the three dimensions is parallel to the optical axis at the downstream end of the light source.

### BRIEF DESCRIPTION OF THE DRAWINGS

The inventive concept will be more clearly understood from the following detailed description of preferred embodiments made in conjunction with the accompanying drawings.

FIG. 1 is a schematic diagram of one embodiment of an optical system according to the inventive concept.

FIG. 2 is a perspective view of a light source.

FIG. 3 is a schematic diagram of the light source of FIG. 2 illustrating the propagation of light emitted by light-emitting devices of the light source.

FIGS. 4 and 5 are images of simulations of light distribution in an optical system of FIG. 1 employing the light source of FIG. 2.

FIGS. 6 and 7 are graphs of the light distribution shown in FIGS. 4 and 5, respectively.

FIG. 8 is a perspective view of a substrate of an example of a light source according to the inventive concept.

FIG. 9 is a perspective view of a substrate of another example of a light source according to the inventive concept.

FIG. 10 is a schematic diagram illustrating propagation directions of lights emitted from light sources according to other example embodiments of the inventive concept.

FIGS. 11 and 12 are images exemplarily illustrating source light distributions in an optical system according to other example embodiments of the inventive concept.

FIGS. 13 and 14 are graphs exemplarily illustrating source light distributions in the optical system according to other example embodiments of the inventive concept.

### DETAILED DESCRIPTION OF THE PREFERRED EMBODIMENTS

Various embodiments and examples of embodiments of the inventive concept will be described more fully hereinafter with reference to the accompanying drawings. Various ones of the drawings are schematic in nature. Also, like numerals are used to designate like or corresponding elements throughout the drawings.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Other terminology used herein for the purpose of describing particular examples or embodiments of the inventive concept is to be taken in context. For example, the terms “comprises” or “comprising” when used in this specification specifies the presence of stated features but does not preclude the presence or additional features.

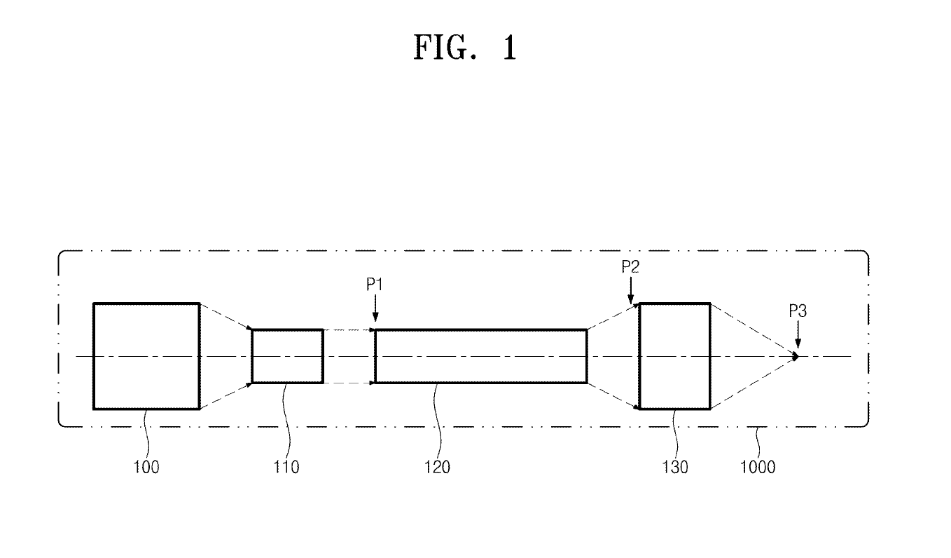

An example of an optical system according to the inventive concept will now be described in detail with reference to FIG. 1.

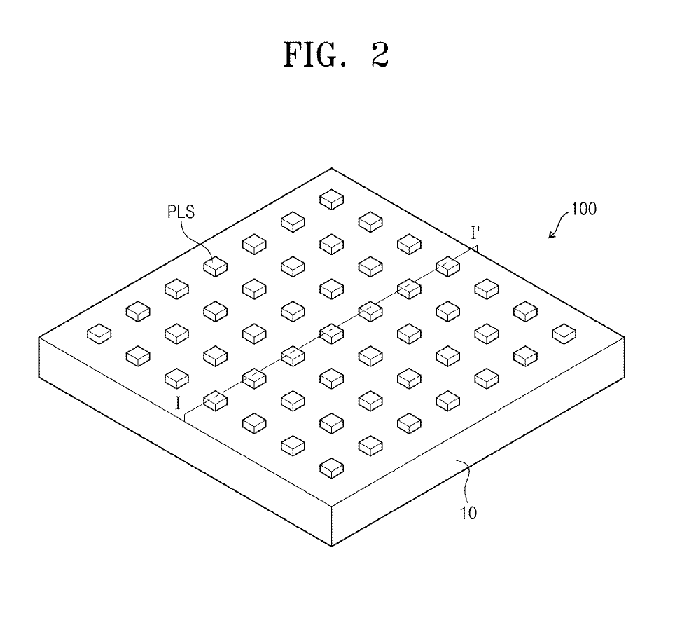

The optical system 1000 of this example includes a light source 100 and a lens system whose optical axis extends between the light source 100 and a target object. The light source 100 may include three-dimensionally arranged light-emitting devices. The light-emitting devices may be point light sources, and examples of arrangements of the light-emitting devices will be described in further detail with reference to FIGS. 2 through 14.

The lens system may include a first lens 110, a second lens 120, and a third lens 130. The first lens 110 may be a relay lens disposed adjacent to the light source 100. The second lens 120 may be a rod-shaped lens provided between the first and third lenses 110 and 130 with respect to the optical axis of the lens system. The third lens 130 may be an objective lens interposed between the second lens 120 and the target object with respect to the optical axis of the lens system, i.e., may be provided at the downstream end of the lens system.

However, an optical system according the inventive concept is not limited to having the lens system shown in FIG. 1. For example, a lens system of an optical system according to the inventive concept may omit at least one of the first to third lens lenses 110, 120, and 130 and/or may include at least one additional lens/type of lens.

One example of an application of the optical system 1000 is as the illuminator of a non-contact type of instrument for testing and/or measuring a property of a semiconductor device.

FIG. 2 shows a light source 100 include a light source substrate 10 and light-emitting devices PLS arranged on the light source substrate 10. In the light source shown in FIG. 2, the light-emitting devices PLS are two-dimensionally arranged (i.e., arranged in rows and columns) on the light source substrate 10. To this end, the light source substrate 10A has a flat surface, and the light-emitting devices PLS are arranged on the flat surface as spaced from each other by regular intervals.

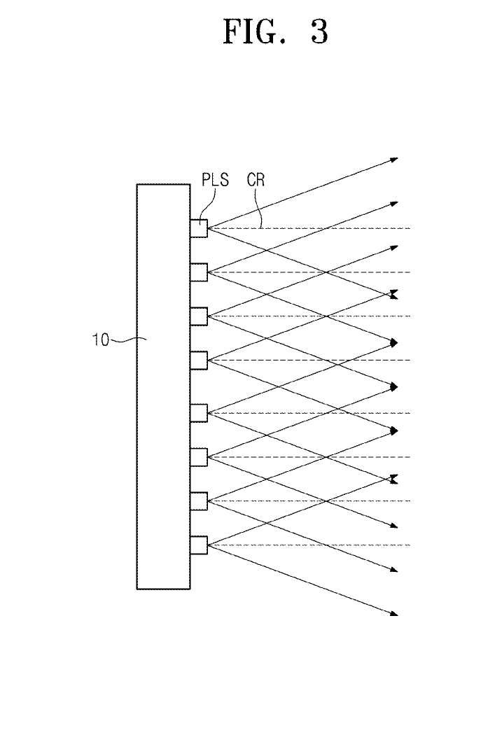

Furthermore, as shown in FIG. 3, each of the light-emitting devices PLS is oriented such that its optical axis (i.e., the direction in which light or a central ray CR of such light, emitted by the device propagates) is substantially normal to the flat surface of substrate 10.

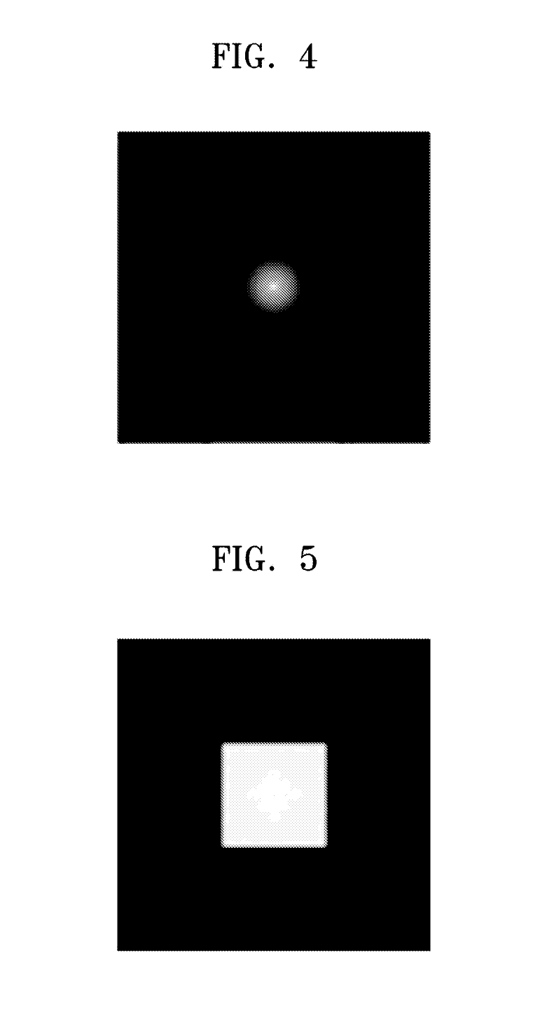

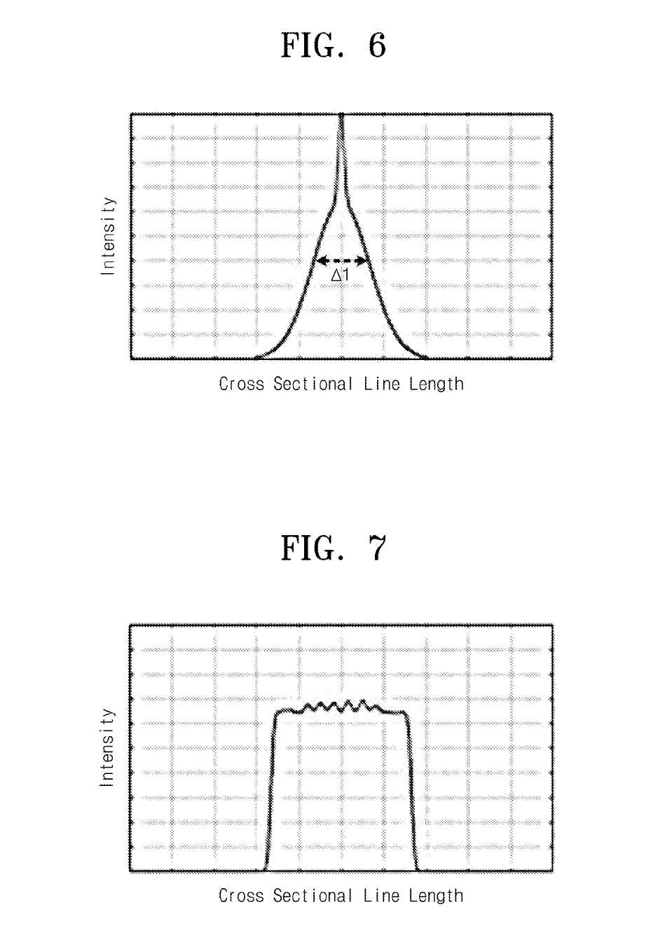

FIGS. 4 and 5 are simulations of images of light distribution the optical system described with reference to FIGS. 2 and 3, and FIGS. 6 and 7 are graphs of the light distribution in a case in which the light source 100A is employed as light source 100. More specifically, FIGS. 4 and 6 are an image and a graph, respectively, illustrating the distribution of light on the pupil (plane) of the objective lens 130 (i.e., plane P2 in FIG. 1), and FIGS. 5 and 7 are an image and a graph, respectively, illustrating the distribution of light on the focal plane of the objective lens 130 (e.g., plane P3 in FIG. 1).

In the case in which the light-emitting devices PLS are two-dimensionally arranged as shown in FIG. 2, light CR emitted from the light source 100A has a narrow angle Δ1 over which the light is distributed, i.e., is concentrated, on the plane of the focal plane, as shown in FIGS. 4 and 6 even though the light CR has a uniform intensity on the pupil of the objective lens.

However, the narrow distribution Δ1 of the light CR may be problematic in some applications. For example, in the case in which the optical system 1000 is used to inspect or test a semiconductor device, a narrow distribution of light CR may yield poor contrast and resolution of the image acquired by the light source.

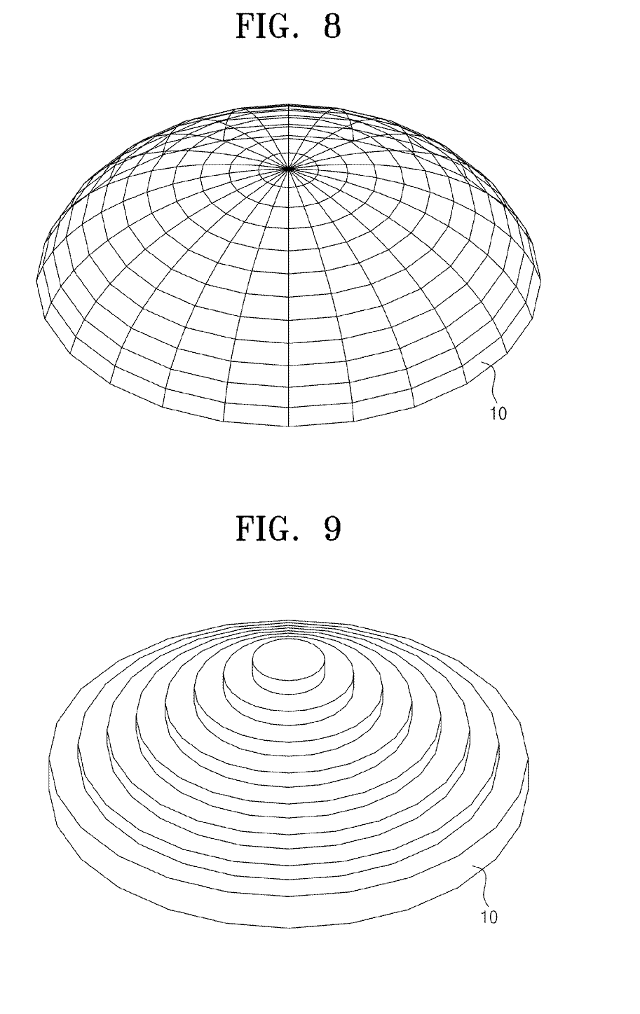

FIGS. 8-10 illustrate examples of light sources according to the inventive concept.

Referring first to FIGS. 8 and 9, a light source substrate 10 of a light source, according to the inventive concept, may have a curved surface (FIG. 8) or a stepped surface (FIG. 9). Light-emitting devices PLS are mounted on the curved or stepped surface of the light source substrate 10. Thus, the light-emitting devices PLS are arranged three-dimensionally on the light source substrate 10.

With respect to the light source serving as the light source 100 in the optical system or illuminator 1000 of FIG. 1, the light-emitting devices PLS are thus arrayed in first and second dimensions that lie in a plane perpendicular to the optical axis (chained line) at a downstream end of the light source with respect to the optical axis, and a third dimension parallel to the optical axis at the downstream end of the light source. Also, in this case, the optical axis of the optical system 1000 is a straight line, and each of the lenses (e.g., 110, 120 and 130) of the optical system has an optical axis coinciding with the optical axis of the illuminator. Accordingly, the lenses (e.g., 110, 120 and 130) are disposed along one straight line.

In the example shown in FIG. 8, the optical substrate surface 10 to which the light-emitting devices may be semi-spherical or elliptical, i.e., may have the sectional profile of a segment of a sphere or of a symmetrical portion of an ellipse. In the example shown in FIG. 9, the optical substrate surface 10 to which the light-emitting devices may be in the form a stepped frustum.

Furthermore, although either example of the light source substrate 10 may have the shape of a disk as viewed in plan, i.e., may have a circular periphery; the inventive concept is not so limited. Rather, the light source substrate 10 may have a polygonal periphery.

Also, as shown in FIGS. 8 and 9, the distance between the surface of the substrate 10 and a line normal to the center of the base of the light source substrate 10 may decrease uniformly or non-uniformly in a direction along that line away from the center. However, in another embodiment, the light source substrate 10 may be configured such that the distance increases or both increases and decreases in the direction along that line away from the center of the base of the light source substrate.

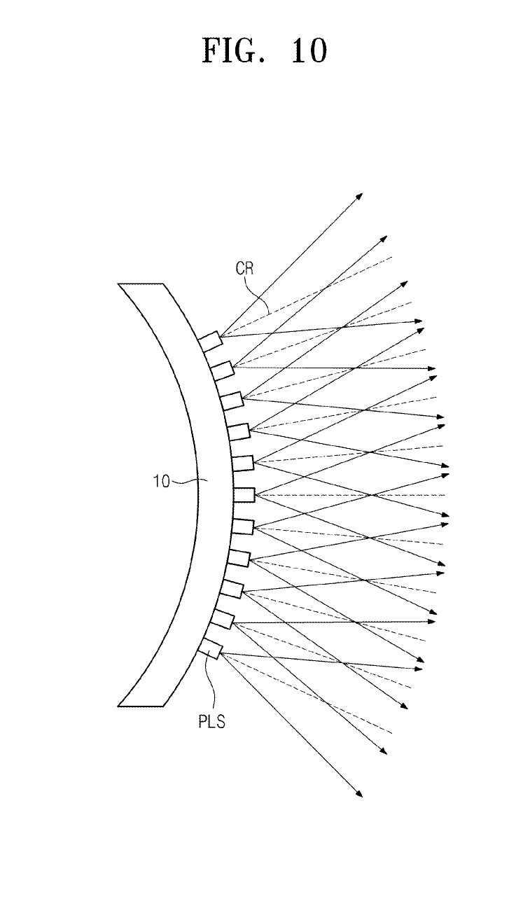

In any case, the light-emitting devices PLS may be oriented such that an optical axis (direction of propagation of the light or central ray CR of light) of each light-emitting device PLS is substantially normal to the curved or stepped surface of the light source substrate 10. More specifically, each light-emitting device PLS is oriented such that the light CR emitted by the device PLS propagates in a direction perpendicular to a plane tangential to the emitting surface of the substrate 10 at the location at which the light-emitting device is mounted to the emitting surface. Furthermore, the directions of the optical axes (directions of propagation of the light or central ray CR of light) of the light-emitting devices PLS may vary, as shown in FIG. 10. That is, the optical axes of the light-emitting devices are non-parallel. In another example, at least one of the optical axes is non-parallel to one or more of the other optical axes.

Each light-emitting device PLS may be a semiconductor device, e.g., a light-emitting diode (LED), which is designed to emit ultraviolet light or deep ultraviolet light. However, LEDs which emit light of other wavelengths may be employed as needed.

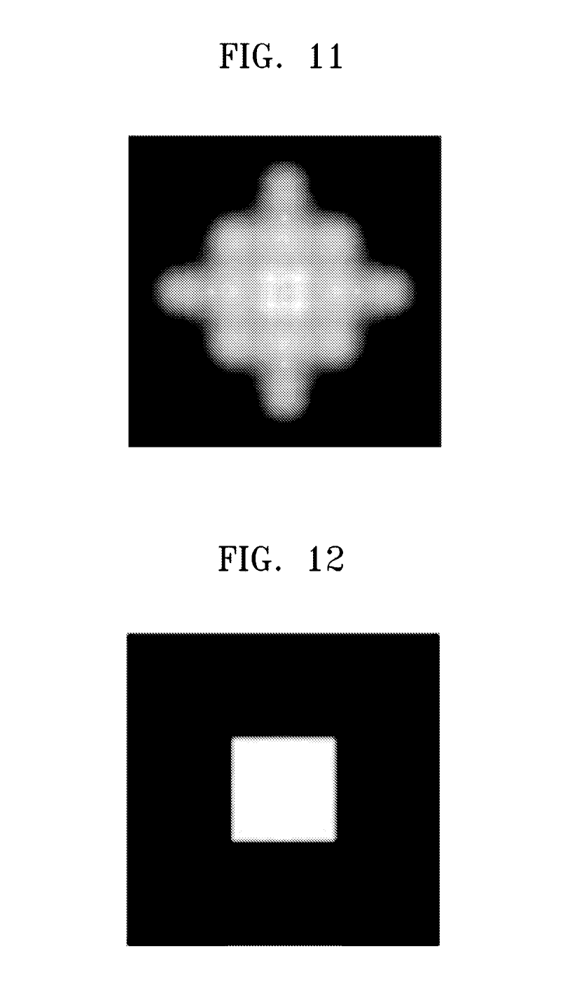

FIGS. 11 through 14 show results obtained from a simulation of an optical system of FIG. 1 including a light source having three-dimensionally arranged light-emitting devices (for example, of the type shown in and described with reference to FIGS. 8 and 10).

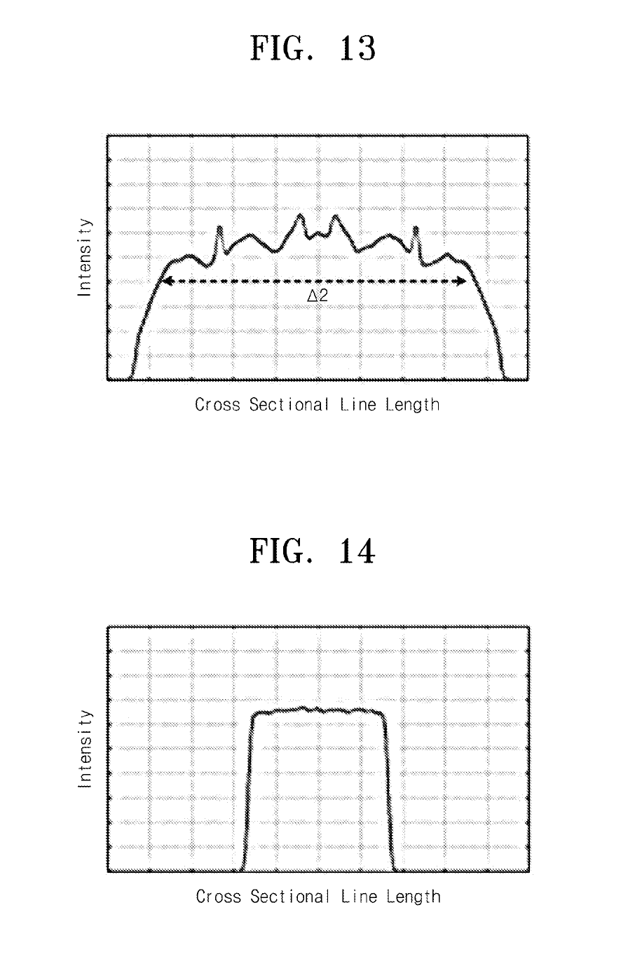

More specifically, FIGS. 11 and 13 are an image and a graph, respectively, illustrating a distribution of light from the light source on the pupil of the objective lens (the second plane P2 in FIG. 1), and FIGS. 12 and 14 are an image and a graph, respectively, illustrating a distribution of light from the light source on a focal plane of the objective lens (the third plane P3 in FIG. 1).

In the case in which the light-emitting devices PLS are three-dimensionally arranged as shown in FIG. 10, the light source 100 emits light CR over a wide angle. That is, as shown in FIG. 13 and comparatively speaking, the distribution 42 of the source light according to the inventive concept, in which the light-emitting devices are arranged three-dimensionally (along orthogonal axes including one parallel to the optical axis of the lens system), is larger than the distribution Δ1 of source light when the light-emitting devices are arranged two-dimensionally (in a plane perpendicular to the optical axis of the lens system), i.e., Δ2>Δ1. For example, the angle Δ2 over which the light is distributed from the center of the light source 100 (FIG. 10) may be three times the angle Δ1 over which the light is distributed from the center of the light source 100A (FIG. 2).

Despite having such a relatively large angle Δ2 of distribution, the source light may be conditioned to have a uniformity that is substantially equal to or higher than that of the comparative example, as shown in FIGS. 12 and 14. The uniformity of the source light may be established by appropriate selection of the effective areas of the incident and emitting surfaces of the second lens 120. Also, in this way, the light from an object to be inspected by being illuminated by the optical system, and transmitted to an image sensor, may be shaped by the optical system to have the same area as the effective area of the image sensor.

According to an aspect of the inventive concept as described above, the light source 100 has three-dimensionally arranged light-emitting devices oriented to distribute light over various angles onto the pupil of the objective lens. Such a three-dimensional arrangement of the light-emitting devices PLS may be achieved by mounting the light-emitting devices PLS on a curved light source substrate 10, as shown in FIGS. 8 and 10. Alternatively, the three-dimensional arrangement of the light-emitting devices PLS may be achieved by mounting the light-emitting devices PLS on a staircase-shaped light source substrate 10, as shown in FIG. 9.

In the case in which light is distributed over a relatively wide angle is incident on the pupil (plane) of the objective lens of the optical system, the optical system can produce an image with high contrast and at a high degree of resolution. Furthermore, the above-described arrangement of the light-emitting devices makes it possible to variably control several optical properties of the source light and to selectively control the intensity of the source light within a given range.

Furthermore, according to an aspect of the inventive concept, a rod-shaped lens may be provided to control the distribution and uniformity of the source light on the pupil or focal plane of the objective lens. For example, a desired distribution and uniformity of the source light can be established by appropriate selection of the areas of incident and emitting surfaces of the rod-shaped lens or of the ratio between such areas.

In other words, according to an aspect of the inventive concept, an optical system (which may be an illuminator) has three-dimensional arrangement of the light-emitting devices constituting its light source and a rod-shaped lens having an incident surface that receives the light from the light source and an emitting surface. Therefore, the optical system may be readily designed and manufactured to produce light of a desired shape and intensity, e.g., an illuminator according to the inventor concept may be readily designed and manufactured to produce light suited for a particular size and sensitivity of an image sensor which is to receive light from an object/scene illuminated by the illuminator. Also, in this way, an optical system according to the inventive concept may employ a minimal number of optical components (lenses and mirrors) and yet produce UV light with a high degree of efficiency. That is, an optical system according to the inventive concept can be produced at a low cost and offer a high degree of efficiency while possessing a small foot print.

Finally, embodiments of the inventive concept and examples thereof have been described above in detail. The inventive concept may, however, be embodied in many different forms and should not be construed as being limited to the embodiments described above. Rather, these embodiments were described so that this disclosure is thorough and complete, and fully conveys the inventive concept to those skilled in the art. Thus, the true spirit and scope of the inventive concept is not limited by the embodiment and examples described above but by the following claims.

What is claimed is:

1. An optical system, comprising:
a light source; and
a lens system,
wherein the light source comprises:
a substrate; and
light-emitting devices arrayed in three dimensions on the substrate.

2. The optical system of claim 1, wherein the substrate has an emitting surface on which the light-emitting devices are mounted, and
the emitting surface has a curved sectional profile comprising a segment of a circle or ellipse.

3. The optical system of claim 1, wherein the optical substrate has an emitting surface on which the light-emitting devices are mounted, and
the emitting surface has a sectional profile in the form of steps.

4. The optical system of claim 1, wherein the light-emitting devices are oriented such that light emitted from each of the devices propagates in a direction different from that of light emitted from at least one other of the devices.

5. The optical system of claim 4, wherein the lens system comprises an objective lens, and the light-emitting devices are disposed upstream of the objective lens with respect to an optical axis of the lens system such that the light emitted by the light-emitting devices are received on a pupil of the objective lens.

6. The optical system of claim 5, wherein the lens system comprises a rod-shaped lens disposed along the optical axis of the lens system between the light source and the pupil of the objective lens.

7. A light source, comprising:
an optical substrate; and
a plurality of light-emitting devices arrayed in three dimensions on the optical substrate.

8. The light source of claim 7, wherein the optical substrate has an emitting surface on which the light-emitting devices are mounted, and
the emitting surface has a curved sectional profile comprising a segment of a circle or ellipse.

9. The light source of claim 7, wherein the optical substrate has an emitting surface on which the light-emitting devices are mounted, and
the emitting surface has a sectional profile in the form of steps.

10. The light source of claim 7, wherein the light-emitting devices are oriented such that light emitted from each of the devices propagates in a direction different from that of light emitted from at least one other of the devices.

11. An illuminator having an optical axis and comprising a light source, and a system of optical components disposed downstream from the light source along the optical axis so as to receive light emitted by the light source, and
the light source comprising a substrate, and light-emitting devices arrayed in three dimensions on the substrate, wherein first and second ones of the three dimensions lie in a plane perpendicular to the optical axis at a downstream end of the light source with respect to the optical axis, and a third one of the three dimensions is parallel to the optical axis at the downstream end of the light source.

12. The illuminator of claim 11, wherein the substrate of the light source has an emitting surface on which the light-emitting devices are mounted, and
the emitting surface has a curved sectional profile comprising a segment of a circle or ellipse.

13. The illuminator of claim 12, wherein each of the light-emitting devices is oriented such that light emitted from the light-emitting device propagates in a direction perpendicular to a plane tangential to the emitting surface at the location at which the light-emitting device is mounted to the emitting surface.

14. The illuminator of claim 11, wherein the substrate of the light source has an emitting surface on which the light-emitting devices are mounted, and
the emitting surface has a sectional profile in the form of steps.

15. The illuminator of claim 11, wherein the light-emitting devices are oriented such that light emitted from each of the devices propagates in a direction different from that of light emitted from at least one other of the devices.

16. The illuminator of claim 11, wherein the light-emitting devices are light emitting diodes.

17. The illuminator of claim 11, wherein the system of optical components consists of lenses including an objective lens at the downstream end of the illuminator with respect to the optical axis.

18. The illuminator of claim 17, wherein the system of optical components further comprises a rod-shaped lens disposed between the light source and the objective lens with respect to the optical axis of the illuminator.

19. The illuminator of claim 17, wherein the optical axis of the illuminator is a straight line, and each of the lenses of the optical system has an optical axis coinciding with the optical axis of the illuminator, whereby the lenses are disposed along one straight line.

20. The illuminator of claim 18, wherein the system of optical components further comprises a rod-shaped lens disposed between the light source and the objective lens.
